(19) United States
(12) Patent Application Publication
(10) Pub. No.: US 2020/0133285 A1
(43) Pub. Date: Apr. 30, 2020

(54) CHASSIS STRUCTURE FOR ROBOT AND ROBOT WITH THE SAME

(71) Applicant: UBTECH ROBOTICS CORP LTD, Shenzhen (CN)

(72) Inventors: Youjun Xiong, Shenzhen (CN); Hailang Zhou, Shenzhen (CN); Xu Hu, Shenzhen (CN)

(21) Appl. No.: 16/436,923

(22) Filed: Jun. 11, 2019

(30) Foreign Application Priority Data
Oct. 31, 2018 (CN) 201811287395.2

(51) Int. Cl. G05D 1/02

(52) U.S. Cl. CPC G05D 1/0223

(57) ABSTRACT

The present disclosure provides a chassis structure for a robot and a robot with the same. The low speed motor provided with an extra encoder is used to compose a driving wheel so as to drive a driven wheel and a chassis to move; a driver module is used to drive the driving wheel through a low speed motor in response to the control of a control processing module, and obtain rotational parameters of the low speed motor through the encoder to output to the control processing module; the control processing module is used to control the driving wheel to rotate through the driver module so as to drive the chassis to move, calculate a movement path of the chassis based on the rotational parameters of the low speed motor, thereby adjusting the movement path of the chassis. In the present disclosure, since there is no transmission mechanism, the efficiency of transmission is improved.

### TRAVERSE REFERENCE TO RELATED APPLICATION PROGRAMS

This application claims priority to Chinese Patent Application No. CN201811287395.2, filed Oct. 31, 2018, which is hereby incorporated by reference herein as if set forth in its entirety.

### BACKGROUND

### 1. Technical Field

The present disclosure relates to automatic control technology, and particularly to a chassis structure for a robot and a robot with the same.

### 2. Description of Related Art

At present, the robot chassis on the market is generally consisted of two (or three) wheel structures and auxiliary wheels. The wheel structure generally includes: high-speed motors, reducers and wheels, and further requires two or three motor controllers and one chassis controller. In this manner, there needs more types and quantities of components, which results in complicated system and high cost. Moreover, due to some connection parts have large noise because of high rotational speed, and the inefficiency because there has many transmission links, which is not suitable for use in the situations where silence is required.

In summary, in the prior art, the robot chassis has problems that complicated in structure, high cost, large noise, and low efficiency.

### BRIEF DESCRIPTION OF THE DRAWINGS

To describe the technical schemes in the embodiments of the present disclosure more clearly, the following briefly introduces the drawings required for describing the embodiments. Apparently, the drawings in the following description merely show some examples of the present disclosure. For those skilled in the art, other drawings can be obtained according to the drawings without creative efforts.

FIG. 1 is a schematic block diagram of a chassis structure for a robot according to an embodiment of the present disclosure.

FIG. 2 is a schematic diagram of a chassis of the chassis structure of FIG. 1.

FIG. 3 is a schematic block diagram of a chassis structure for a robot according to another embodiment of the present disclosure.

### DETAILED DESCRIPTION

In order to make those skilled in the art to understand the present disclosure in a better manner, the technical solutions in the embodiments of the present disclosure will be clearly described below in conjunction with the drawings in the embodiments of the present disclosure. Apparently, the following embodiments are only part of the embodiments of the present disclosure, not all of the embodiments of the present disclosure. All other embodiments obtained by those skilled in the art without creative efforts are within the scope of the present disclosure.

The terms “comprising”, “including”, and any other variants in the specification, the claims, and the above-mentioned drawings of the present disclosure mean “including but not limited to” and are intended to cover non-exclusive inclusion. Moreover, the terms “first” and “second” and the like are used to distinguish different objects and are not intended to describe a particular order.

In the description of the present disclosure, it is to be understood that the orientations or the positional relationships indicated by the terms “upper”, “lower”, “front”, “back”, “left”, “right”, “vertical”, “horizontal”, “top”, “bottom”, “inside”, “outside” are based on the orientations or the positional relationships shown in the drawings, and are merely for the convenience of describing the present disclosure and simplifying the description, rather than indicating or implying the referred device or component must have a specific orientation or be constructed and operated in a specific orientation, and are therefore cannot be understood as the limitations of the present disclosure.

The implementation of the present disclosure is described in detail below with reference to the specific drawings:

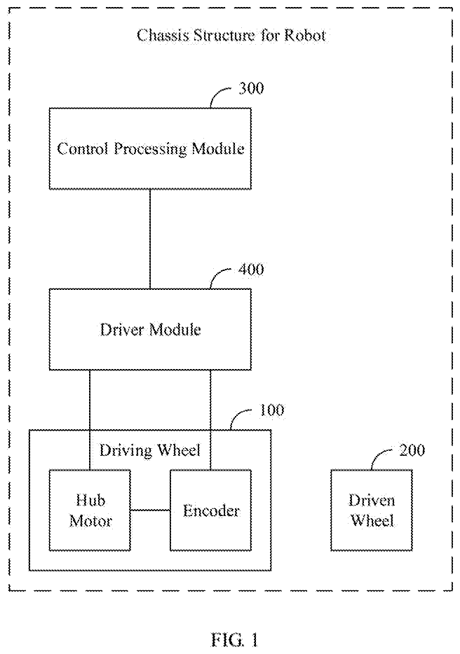

FIG. 1 is a schematic block diagram of a chassis structure for a robot according to an embodiment of the present disclosure. For convenience of description, only parts related to this embodiment are shown, which are described in detail as follows.

As shown in FIG. 1, a chassis structure for a robot is provided. The chassis structure includes a chassis. In this embodiment, the chassis structure is applied to a robot such as a mobile robot, a service robot, or an industrial robot by, for example, using the chassis structure as a chassis of the robot. In other embodiments, the chassis structure can applied to other type of machines. The chassis is provided with a driving wheel 100, a driven wheel 200, a control processing module 300 and a driver module 400. The driving wheel 100 includes a low speed motor and an encoder. In this embodiment, the low speed motor is a motor without gear reducer such as a hub motor.

The control processing module 300 is coupled to the driver module 400, the driver module 400 is coupled to each of the low speed motor and the encoder, and the low speed motor is coupled to the encoder.

The driving wheel 100 is configured to drive the driven wheel 200 and the chassis to move.

The driver module 400 is configured to drive the driving wheel 100 through the low speed motor in response to a control of the control processing module 300, and obtain rotational parameters of the low speed motor through the encoder to output to the control processing module 300.

The control processing module 300 is configured to control the driving wheel 100 to rotate through the driver module 400 so as to drive the chassis to move, calculate a movement path of the chassis based on the rotational parameters of the low speed motor, and adjust the movement pah of the chassis.

In one embodiment, the model of the control processing module 300 is STM32F407.

In one embodiment, the rotational parameters of the low speed motor include a rotational angular velocity, a rotational direction, a motor current, and a motor voltage.

In this embodiment, the low speed motor provided with an extra encoder is used to compose the driving wheel so as to drive the driven wheel and the chassis to move; the driver module is used to drive the driving wheel through the low speed motor in response to the control of the control processing module, and obtain rotational parameters of the low speed motor through the encoder to output to the control processing module; the control processing module is used to control the driving wheel to rotate through the driver module so as to drive the chassis to move, calculate the movement path of the chassis based on the rotational parameters of the low speed motor, thereby adjusting the movement path of the chassis. In this embodiment, since there is no transmission mechanism, the efficiency of transmission is improved. The two-in-one combination of the wheel and the motor simplifies the structure of the chassis, which reduces the cost of components, and realizes the mute effect because the rotation noise of the low speed motor is small. The robots adopt the chassis of this embodiment can be used in the situations where silence is required, for example, a library, a workplace, and the like.

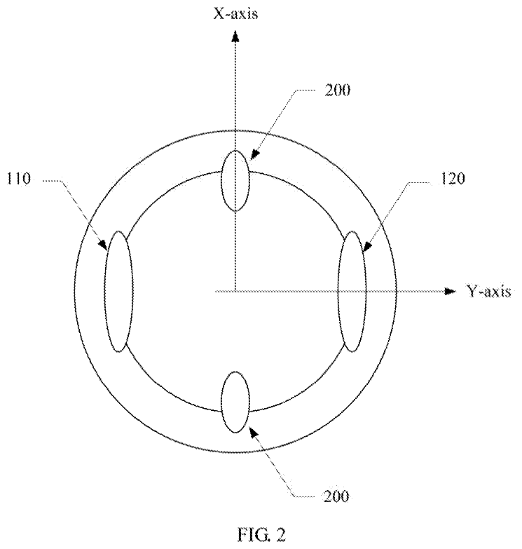

FIG. 2 is a schematic diagram of a chassis of the chassis structure of FIG. 1. As shown in FIG. 2, in this embodiment, two driving wheels 100 are disposed on a bottom surface of the chassis, which are respectively a first driving wheel 110 and a second driving wheel 120. The first driving wheel 110 and the second driving wheel 120 are symmetrically distributed on both sides of a central axis of the bottom surface. The first driving wheel 110 includes a first low speed motor and a first encoder coupled to the first low speed motor, and the second driving wheel 120 includes a second low speed motor and a second encoder coupled to the second low speed motor.

As shown in FIG. 2, the first driving wheel 110 and the second driving wheel 120 may be symmetrically distributed on the left side and the right side of the chassis.

As shown in FIG. 2, the bottom surface of the chassis may be disposed with two driven wheels 200 which are symmetrically distributed on an upper side and a lower side of the chassis.

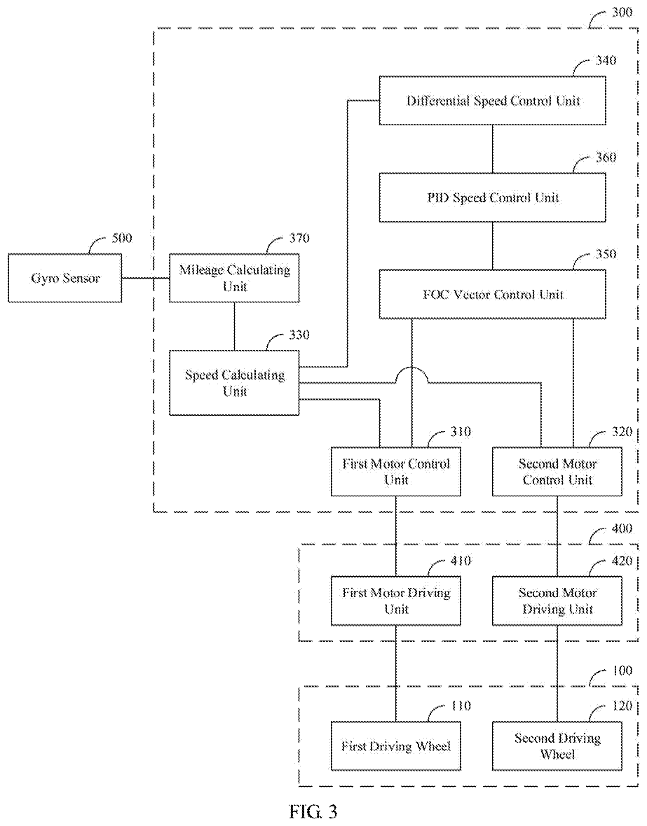

FIG. 3 is a schematic block diagram of a chassis structure for a robot according to another embodiment of the present disclosure. As shown in FIG. 3, in this embodiment, the driver module 400 includes a first motor driving unit 410 and a second motor driving unit 420. The first motor driving unit 410 is coupled to the first driving wheel 110, and the second motor driving unit 420 is coupled to the second driving wheel 120.

The control processing module 300 includes a first motor control unit 310 and a second motor control unit 320. The first motor control unit 310 is coupled to the first motor driving unit 410, and the second motor control unit 320 is coupled to the second motor driving unit 420.

The first motor control unit 310 is configured to control the first driving wheel 110 to rotate through the first motor driving unit 410 and sample rotational parameter of the first driving wheel 110 through the first motor driving unit 410.

The second motor control unit 320 is configured to control the second driving wheel 120 to rotate through the second motor driving unit 420 and sample the rotational parameter of the second driving wheel 120 through the second motor driving unit 420.

In one embodiment, the first motor driving unit 410 is coupled to each of the first low speed motor and the first encoder, and the second motor driving unit 420 is coupled to each of the second low speed motor and the second encoder.

In one embodiment, the first motor driving unit 410 is configured to receive a control instruction output by the first motor control unit 310 to drive the first driving wheel 110 to rotate.

In one embodiment, the second motor driving unit 420 is configured to receive a control instruction output by the second motor control unit 320 to drive the second driving wheel 120 to rotate.

In one embodiment, the model of the first motor driving unit 410 and the second motor driving unit 420 is STM32F407.

As shown in FIG. 3, in this embodiment, the control processing module 300 further includes a speed calculating unit 330 coupled to each of the first motor control unit 310 and the second motor control unit 320.

The speed calculating unit 330 is configured to obtain a rotational angular velocity of the first driving wheel 110 which is sampled by the first motor control unit 310 and a rotational angular velocity of the second driving wheel 120 which is sampled by the second motor control unit 320, and calculate a movement speed and an angular velocity of the chassis.

In this embodiment, the first motor driving unit 410 obtains the rotational angular velocity of the first low speed motor which is fed back by the first encoder, that is, the rotational angular velocity of the first driving wheel 110. The first motor control unit 310 samples the rotational angular velocity, where a time interval between two adjacent samplings is a sampling time.

In this embodiment, the second motor driving unit 420 obtains the rotational angular velocity of the second low speed motor which is fed back by the second encoder, that is, the rotational angular velocity of the second driving wheel 120. The second motor control unit 320 samples the rotational angular velocity, where a time interval between two adjacent samplings is a sampling time.

In this embodiment, the speed calculating unit 330 is configured to calculate the movement speed and the angular velocity of the chassis based on the rotational angular velocity of the first driving wheel 110 and the rotational angular velocity of the second driving wheel 120, which is capable of realizing the real-time detection of current movement parameters of the chassis, thereby realizing the real-time monitoring of the movement path of the chassis.

In one embodiment, the movement parameters of the chassis include a movement speed, an angular velocity, a movement direction, a coordinate, the movement path, and the like.

In one embodiment, the speed calculating unit 330 is configured to calculate the movement speed and the angular velocity of the chassis based on speed formulas as the follows:

$$S = 2 π r * {S}_{L} + 2 π r * {S}_{R} ; and$$

$$ω = \frac{2 π r * {S}_{L} - 2 π r * {S}_{R}}{R} ;$$

where, S is the movement speed of the chassis in a X-axis direction, r is the radius of the driving wheel, S_{L} is the rotational angular velocity of the first driving wheel, S_{R} is the rotational angular velocity of the second driving wheel, ω is the angular velocity of the chassis, and R is a gyration radius of the chassis; in which, a line between a center of the first driving wheel and a center of the second driving wheel is a Y-axis direction, and the X-axis direction is a direction perpendicular to the Y-axis direction on the bottom surface.

In this embodiment, as shown in FIG. 2, the line between the center of the first driving wheel and the center of the second driving wheel is the Y-axis direction, the X-axis direction is the direction perpendicular to the Y-axis direction on the bottom surface of the chassis, and the Y-axis direction and the X-axis direction form a plane coordinate system parallel to the bottom surface.

In such a manner, the movement speed S of the chassis in the X-axis direction and the angular velocity ω of the chassis are obtained.

In one embodiment, since the first motor control unit 310 and the second motor control unit 320 sample the rotational angular velocity at a time interval, the value obtained by each sampling may change. Hence, S_{L} is a mean value of the rotational angular velocity of the first driving wheel 110 that is sampled within a preset time. wheel, and S_{R} is a mean value of the rotational angular velocity of the second driving wheel 120 that is sampled within a preset time.

As shown in FIG. 3, in an embodiment of the present disclosure, the control processing module 300 further includes a differential speed control unit 340. The differential speed control unit 340 is coupled to each of the speed calculating unit 330, the first motor control unit 310, and the second motor control unit 320.

The differential speed control unit 340 is configured to obtain a conversion relationship between the movement speed and the angular velocity of the chassis as well as the rotational angular velocity of the driving wheel which are obtained by the speed calculating unit 330, obtain wheel speed control data based on the conversion relationship, and output the wheel speed control data to the first motor control unit 310 and the second motor control unit 320 to adjust the one or more rotational parameters of the first driving wheel 110 and the second driving wheel 120, respectively, such that the chassis moves in accordance with the preset movement path.

In one embodiment, the differential speed control unit 340 reversely calculates the required rotational angular velocity of the first driving wheel 110 and the required rotational angular velocity of the second driving wheel 120 based on a required target movement speed and target angular velocity of the chassis in accordance with the speed formulas used by the speed calculating unit 330, thereby obtaining the wheel speed control data.

The first motor control unit 310 and the second motor control unit 320 adjust the rotational parameters of the first driving wheel 110 and the second driving wheel 120 according to the wheel speed control data.

Taking a specific applicaton scenario as an example, the movement parameters will change at any time during the movement of the chassis. A change ratio of the movement parameters can be obtained based on the preset movement path. For example, when accelerating or decelerating, the change ratio can be obtained by dividing the target movement speed with the current movement speed.

According to the change ratio of the movement speed of the chassis, the rotational angular velocity of the first driving wheel 110 and the rotational angular velocity of the second driving wheel 120 can be adjusted in the same ratio. For example, if the target movement speed of the chassis is to be changed to 60% of the current movement speed, in accordance with S=2πr*S_{L}+2πr*S_{R}, it can be known that S can be attenuated by 60% just through multiplying S_{L} and S_{R} by a coefficient of 60% simultaneously. Then, the result of the reversely calculate is to convert the rotational angular velocity of the first driving wheel 110 and the rotational angular velocity of the second driving wheel 120 to 60% of the current rotational angular velocity, and the wheel speed control data is 60%. Similarly, according to the change ratio of the angular velocity of the chassis, the rotational angular velocity of the first driving wheel 110 and the rotational angular velocity of the second driving wheel 120 can be adjusted in the same ratio.

In this embodiment, the differential speed control of the first driving wheel 110 and the second driving wheel 120 is realized, and the rotational angular velocity can be adjusted in real time through the wheel speed control data so as to meet the needs.

As shown in FIG. 3, in one embodiment, the control processing module 300 further includes a FOC (field oriented control) vector control unit 350 and a PID (proportion, integral, and derivative) speed control unit 360. The PID speed control unit 360 is coupled to each of the differential speed control unit 340 and the FOC vector control unit 350, the FOC vector control unit 350 is coupled to each of the first motor control unit 310 and the second motor control unit 320.

The PID speed control unit 360 is configured to obtain the wheel speed control data and the current one or more rotational parameters of the driving wheel, perform a closed-loop feedback adjustment on the wheel speed control data based on the current one or more rotational parameters, and output the adjusted wheel speed control data.

The FOC vector control unit 350 is configured to obtain the adjusted wheel speed control data to convert into a vector so as to perform a vector control on the low speed motor.

In this embodiment, PID control is a closed-loop automatic control technique. The wheel speed control data for realizing the rotation control is adjusted through the current rotation condition (i.e., the rotational parameters), and at the same time, after the wheel speed control data changed, the rotational parameters also changed accordingly. In this way, a closed-loop feedback adjustment process is implemented.

In this embodiment, FOC vector control is a technique that uses a vector to control a motor. The vector includes vector values of three-phase current and voltage output to the low speed motor to control the low speed motor. The control of the motor is realized by vector control, which has the advantage of smooth torque and small impact on the movement structure, and can reduce the noise generated by the structural resonance.

As shown in FIG. 3, in one embodiment, the control processing module 300 further includes a mileage calculating unit 370. The mileage calculating unit 370 is coupled to the speed calculating unit 300.

The mileage calculating unit 370 is configured to calculate the movement path of the chassis based on the rotational angular velocity of the first driving wheel 110 which is sampled by the first motor control unit 310 and the rotational angular velocity of the second driving wheel 120 which is sampled by the second motor control unit 320.

In this embodiment, the mileage calculating unit 370 positions the position of the movement of the chassis according to the rotational angular velocity of the first driving wheel 110 and the rotational angular velocity of the second driving wheel 120, thereby obtaining the movement path of the chassis.

In one embodiment, the mileage calculating unit 370 is configured to calculate the movement path of the chassis through formulas as follows:

ΔU_{Li}=Δt*S_{Li};

where, i is an amount of times of sampling of the first motor control unit or the second motor control unit;

ΔU_{Li} is a rotation distance of the first driving wheel in the i-th sampling, Δt is the time of the i-th sampling, and S_{Li} is the rotational angular velocity of the first driving wheel in the i-th sampling;

ΔU_{Ri}=Δt*S_{Ri};

where, ΔU_{Ri} is a rotational distance of the second driving wheel in the i-th sampling, and S_{Ri} is the rotational angular velocity of the second driving wheel in the i-th sampling;

assuming that:

$$Δ {U}_{1} = \frac{Δ {U}_{R 1} + Δ {U}_{L 1}}{2} ; and$$

$$Δ {θ}_{1} = \frac{Δ {U}_{R 1} - Δ {U}_{L 1}}{2 R} ;$$

where, ΔUᵢ is a movement distance of the chassis in the i-th sampling, and Δθᵢ is a movement angle of the chassis in the i-th sampling;

obtaining:

$$\{ \begin{matrix}{θ}_{i} = {θ}_{i - 1} + {Δθ}_{i} \\ {X}_{i} = {X}_{i - 1} + Δ {U}_{i} cos {θ}_{i} ; \\ {Y}_{i} = {Y}_{i - 1} + Δ {U}_{i} sin {θ}_{i}\end{matrix}$$

where, θᵢ is a moving direction of the chassis to move on a plane coordinate system, Xᵢ is the X-axis coordinate of the chassis to move on the plane coordinate system, and Yᵢ is the Y-axis coordinate of the chassis to move on the plane coordinate system.

In one embodiment, a line between a center of the first driving wheel and a center of the second driving wheel is a Y-axis direction, and a direction perpendicular to the Y-axis direction on the bottom surface is an X-axis direction, and a Cartesian coordinate system composed of the Y-axis direction and the X-axis direction is the plane coordinate system.

As shown in FIG. 3, in one embodiment, the chassis is further provided with a gyro sensor 500. The gyro sensor 500 is coupled to the control processing module 300 through a communication interface.

The gyro sensor 500 is configured to send the measured angular velocity of the chassis to the control processing module 300, so that the control processing module 300 corrects the calculated movement path of the chassis.

In one embodiment, the gyro sensor 500 is coupled to the control processing module 300 via an I2C interface.

In this embodiment, the gyro sensor 500 can detect the angular velocity of the chassis when it is deflected or tilted.

The control processing module 300 can correct the calculated movement path by using the angular velocity of the chassis that is detected through the gyro sensor 500.

In one embodiment, the chassis structure for a robot further includes a power module. The power module is coupled to each of the driving wheel 100, the control processing module 300, and the driver module 400, and provides a power supply voltage for each of them to operate.

The power module includes a battery unit, a DC voltage conversion unit, and a linear voltage stabilizing unit which are connected in sequence.

In one embodiment, the battery unit outputs a first direct current of 24V (volt). The DC voltage conversion unit converts the first direct current into a second direct current of 5V, and the linear voltage stabilizing unit converts the second direct current into a third direct current of 3.3V.

In one embodiment, the linear voltage stabilizing unit includes an LDO (low dropout regulator).

In one embodiment, the chassis structure for a robot further includes a communication interface module. The communication interface module is coupled to each of the control processing module 300 and the gyro sensor 500.

The communication interlace module includes a CAN interface unit, a UART interlace unit, an I2C interface unit, a network interface unit, and a serial interface unit.

The above-mentioned embodiment realizes a chassis structure for a robot, which has the advantages of simple structure, low cost, long service life, easy production and maintenance, and low noise. It expanding the application scope of the robot, which is mature in its technique while has low risk, high reliability, and high efficiency and saves energy.

It should be noted that, the ports or pins with the same reference numerals in tire specification and the drawings are communicated with each other.

The above-mentioned embodiments are only for illustrating the technical solutions of the present disclosure, which are not limitations to the present disclosure. Although the present disclosure has been described in detail with reference to the above-mentioned embodiments, those skilled in the art should understand that, the technical solutions described in the embodiments can still be modified, or some of the technical features therein can be equivaiently substituted, while these modifications or substitutions will not make the essence of the corresponding technical solution departs from the spirit and scope of the technical solutions of each embodiment of the present disclosure.

What is claimed is:

1. A chassis structure for a robot, comprising:
a chassis;
a control processing module disposed on the chassis, wherein the control processing module comprises a first motor control unit, a second motor control unit, and a differential speed control unit coupled to each of the first motor control unit and the second motor control unit;
a driver module disposed on the chassis and coupled to the control processing module, wherein the first motor control unit und the second motor control unit are coupled to the driver module;
a first driving wheel and a second driving wheel disposed on the chassis, wherein the first driving wheel comprises a first low speed motor and a first encoder coupled to the first low speed motor, and the second driving wheel comprises a second low speed motor and a second encoder coupled to the second low speed motor; wherein the driver module is coupled to each of the first low speed motor, the first encoder, the second low speed motor, and the second encoder; the first motor control unit is configured to control the first driving wheel to rotate and sample one or more rotational parameters of the first driving wheel; the second motor control unit is configured to control the second driving wheel to rotate and sample one or more rotational parameters of the second driving wheel; wherein the differential speed control unit is configured to obtain a conversion relationship between a movement speed of the chassis and the and an rotational angular velocity of the driving wheels, obtain wheel speed control data based on the conversion relationship, and output the wheel speed control data to the first motor control unit and the second motor control unit to adjust the one or more rotational parameters of the first driving wheel and the second driving wheel, respectively, such that the chassis moves in accordance with a preset movement path; and
a driven wheel disposed on the chassis;
low speed low speed
wherein, the driving wheel is configured to drive the driven wheel and the chassis to move;
wherein, the driver module is configured to drive the driving wheel through the low speed motor in response to a control of the control processing module, and obtain one or more rotational parameters of the low speed motor through the encoder to output to the control processing module; and
wherein, the control processing module is configured to control the driving wheel to rotate through the driver module so as to drive the chassis to move, calculate a movement path of the chassis based on the one or more rotational parameters of the low speed motor, and adjust the movement path of the chassis.

2. The chassis structure of claim 1, wherein a bottom surface of the chassis is provided with the two driving wheels comprising the first driving wheel and the second driving wheel; the first driving wheel and tie second driving wheel are symmetrically distributed on both sides of a central axis of the bottom surface.

3. The chassis structure of claim 2, wherein the driver module comprises a first motor driving unit and a second motor driving unit; the first motor driving unit is coupled to the first driving wheel, and the second motor driving unit is coupled to the second driving wheel;
the first motor control unit of the control processing module is coupled to the first motor driving unit, and the second motor control unit of the control processing module is coupled to the second motor driving unit;
the first motor control unit is configured to control the first driving wheel to rotate through the first motor driving unit and sample the one or more rotational parameters of the first driving wheel through the first irotor driving unit;
the second motor control unit is configured to control the second driving wheel to rotate through the second motor driving unit and sample the one or more rotational parameters of the second driving wheel through the second motor driving unit;

4. The chassis structure of claim 3, wherein the control processing module further comprises a speed calculating unit coupled to each of the first motor control unit and the second motor control unit; the speed calculating unit is configured to obtain the rotational angular velocity of the first driving wheel sampled by the first motor control unit and the rotational angular velocity of the second driving wheel sampled by the second motor control unit, and calculate the movement speed and an angular velocity of the chassis.

5. The chassis structure of claim 4, wherein the speed calculating unit is configured to calculate the movement speed and the angular velocity of the chassis based on speed formulas as the follows:
$$S = 2 π r * {S}_{L} + 2 π r * {S}_{R} ; and$$
$$ω = \frac{2 π r * {S}_{L} - 2 π r * {S}_{R}}{R} ;$$
where, S is the movement speed of the chassis in a X-axis direction, r is the radius of the driving wheel, S_{L} is the rotational angular velocity of the first driving wheel, S_{R} is the rotational angular velocity of the second driving wheel, ω is the angular velocity of the chassis, and R is a gyration radius of the chassis; a line between a center of the first driving wheel and a center of the secord driving wheel is a Y-axis direction, and the X-axis direction is a direction perpencicular to the Y-axis direction on the bottom surface.

6. The chassis structure of claim 4, wherein the differential speed control unit is coupled to each of the speed calculating unit, the first motor control unit, and the second motor control unit; wherein the differential speed control unit is configured to obtain the conversion relationship between the movement speed and the angular velocity of the chassis and the rotational angular velocity of the driving wheel obtained by the speed calculating unit, obtain wheel speed control data based on the conversion relationship, and output the wheel speed control data to the first motor control unit and the second motor control unit to adjust the one or more rotational parameters of the first driving wheel and the second driving wheel, respectively, such that the chassis moves in accordance with the preset movement path.

7. The chassis structure of claim 6, wherein the control processing module further comprises a FOC vector control unit and a PID speed control unit; wherein the PID speed control unit is coupled to each of the differential speed control unit and the FOC vector control unit, the FOC vector control unit is coupled to each of the first motor control unit and the second motor control unit;
the PID speed control unit is configured to obtain the wheel speed control data and the current one or more rotational parameters of the driving wheel, perform a closed-loop feedback adjustment on the wheel speed control data based on the current one or more rotational parameters, and output the adjusted wheel speed control data; and
the FOC vector control unit is configured to obtain the adjusted wheel speed control data to convert into a vector so is to perform a vector control on the low speed motor.

8. The chassis structure of claim 4, wherein the control processing module further comprises a mileage calculating unit is coupled to the speed calculating unit; wherein the mileage calculating unit is configured to calculate the movement path of the chassis based on the rotational angular velocity of the first driving wheel sampled by the first motor control unit and the rotational angular velocity of the second driving wheel sampled by the second motor control unit.

9. The chassis structure of claim 8, wherein the mileage calculating unit calculates the movement path of the chassis through formulas as follows:
ΔU_{Li}=Δt*S_{Li};
where, i is an amount of times of sampling of the first motor control unit or the second motor control unit;
ΔU_{Li} is a rotation distance of the first driving wheel in the i-th sampling, Δt is the time of the i-th sampling, and S_{Li} is the rotational angular velocity of the first driving wheel in the i-th sampling;
ΔU_{Ri}=Δt*S_{Ri};
where, ΔU_{Ri} is a rotational distance of the second driving wheel in the i-th sampling, and S_{Ri} is the rotational angular velocity of the second driving wheel in the i-th sampling;
assuming that:
$$Δ {U}_{1} = \frac{Δ {U}_{R 1} + Δ {U}_{L 1}}{2} ; and$$
$$Δ {θ}_{1} = \frac{Δ {U}_{R 1} - Δ {U}_{L 1}}{2 R} ;$$
where, ΔUᵢ is a movement distance of the chassis in the i-th sampling, and Δθᵢ is a movement angle of the chassis in the i-th sampling;
obtaining:
$$\{ \begin{matrix}{θ}_{i} = {θ}_{i - 1} + {Δθ}_{i} \\ {X}_{i} = {X}_{i - 2} + Δ {U}_{i} cos {θ}_{i} ; \\ {Y}_{i} = {Y}_{i - 1} + Δ {U}_{i} sin {θ}_{i}\end{matrix}$$
where, θᵢ is a moving direction of the chassis to move on a plane coordinate system, Xᵢ is the X-axis coordinate of the chassis to move on the plane coordinate system, and Yᵢ is the Y-axis coordinate of the chassis to move on the plane coordinate system.

10. The chassis structure claim 1, wherein the chassis is further provided with a gyro sensor; the gyro sensor is coupled to the control processing module through a communication interface; wherein the gyro sensor is configured to send the measured angular velocity of the chassis to the control processing module, so that the control processing module corrects the calculated movement path of the chassis.

11. A robot, comprising:
a chassis;
a control processing module disposed on the chassis, wherein the control processing module comprises a first motor control unit, a second motor control unit, and a differential speed control unit coupled to each of the first motor control unit and the second motor control unit;
a driver module disposed on the chassis and coupled to the control processing module, wherein the first motor control unit und the second motor control unit are coupled to the driver module;
a first driving wheel and a second driving wheel disposed on the chassis, wherein the first driving wheel comprises a first low speed motor and a first encoder coupled to the first low speed motor, and the second driving wheel comprises a second low speed motor and a second encoder coupled to the second low speed motor; wherein the driver module is coupled to each of the first low speed motor, the first encoder, the second low speed motor, and the second encoder; the first motor control unit is configured to control the first driving wheel to rotate and sample one or more rotational parameters of the first driving wheel; the second motor control unit is configured to control the second driving wheel to rotate and sample one or more rotational parameters of the second driving wheel; wherein the differential speed control unit is configured to obtain a conversion relationship between a movement speed of the chassis and the and an rotational angular velocity of the driving wheels, obtain wheel speed control data based on the conversion relationship, and output the wheel speed control data to the first motor control unit and the second motor control unit to adjust the one or more rotational parameters of the first driving wheel and the second driving wheel, respectively, such that the chassis moves in accordance with a preset movement path; and
a driven wheel disposed on the chassis;
wherein, the driving wheel is configured to drive the driven wheel and the chassis to move;
wherein, the driver module is configured to drive the driving wheel through the low speed motor in response to a control of the control processing module, and obtain one or more rotational parameters of the low speed motor through the encoder to output to the control processing module; and
wherein, the control processing module is configured to control the driving wheel to rotate through the driver module so as to drive the chassis to move, calculate a movement path of the chassis based on the one or more rotational parameters of the low speed motor, and adjust the movement pah of the chassis.
